(19) United States
(12) Patent Application Publication
(10) Pub. No.: US 2014/0078065 A1
(43) Pub. Date: Mar. 20, 2014

(54) Predictive Keyboard With Suppressed Keys

(71) Applicant: Ahmet Akkok, Istanbul (TR)

(72) Inventor: Ahmet Akkok, Istanbul (TR)

(21) Appl. No.: 13/620,836

(22) Filed: Sep. 15, 2012

(51) Int. Cl. G06F 3/023

(52) U.S. Cl. CPC G06F 3/0237; G06F 3/0236
USPC 345/169

(57) ABSTRACT

A method of predicting keys have a probability to be entered next and suppressing keys those are not predicted as likely to be entered next on soft keyboards. The method displays a soft keyboard where only the predicted keys are displayed on the soft keyboard where the leftover space from suppressed keys are apportioned among predicted keys. So predicted keys may be larger in size on the soft keyboard. This makes the predicted keys more easily typed by users as compared to the other keys.

### CROSS-REFERENCE TO RELATED APPLICATIONS

Not Applicable

### BACKGROUND OF THE INVENTION

Small computerized devices such as smart phones and tablets have become increasingly popular. These devices have touch sensitive screen for text and data entry. An image of a regular keyboard is displayed on the display, such that a user is able to select which key to “type” next by tapping on the image of the keyboard corresponding to the desired key. Such an image of a keyboard being displayed on the display of a device to provide for text and data entry by tapping the the image corresponding to keys of the keyboard, is known as a “soft” keyboard.

A disadvantage with such soft keyboards is, however, that the displayed keys of the keyboard on the display of the device are small, since the display of the device as well as the device itself are small. Especially when QWERTY keyboard layout is used, the keyboard keys on the display got much smaller comparison to regular keyboards. This is the case especially for devices with small display such as mobile phones. Unlike regular keyboards it is not possible for fingers to feel borders between keys. This means that users are apt to tap incorrect keys, especially when “typing” quickly, and also that users are apt to type more slowly using soft keyboards, because of the dexterity required in order to achieve a high accuracy rate when typing. This limits the usefulness of these devices, since they cannot very conveniently be used for quick and/or large amounts of text and data entry. For this and other reasons, there is a need for the present invention.

### BRIEF SUMMARY OF THE INVENTION

The invention aims to improve typing experience in soft keyboards for touch screen devices. This is done dynamically by suppressing the keys those are not likely to be typed next. Remaining keys are predicted as likely to be the next key desired to be entered by the user in the key sequence. Predicted keys expand towards the leftover space from suppressed keys. Predicted keys are now displayed as larger in size, so easier to type on the soft keyboard.

In the following description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

### BRIEF DESCRIPTION OF THE SEVERAL VIEWS OF THE DRAWING

FIG. 1: illustrates a soft keyboard with QWERTY layout on a portion of a touch-sensitive display device.

FIG. 2: illustrates default centers of the keys in a soft keyboard, where each dot represents default center of corresponding key.

FIG. 3: illustrates a soft keyboard according to an embodiment of the invention where all predicted keys have rectangular shapes after expanding towards the leftover space from suppressed keys.

FIG. 4: illustrates a soft keyboard according to an embodiment of the invention where predicted keys have orthogonal borderlines after expanding towards the leftover space from suppressed keys.

FIG. 5: illustrates a soft keyboard according to an embodiment of the invention where predicted keys have skew borderlines after expanding towards the leftover space from suppressed keys.

FIG. 6: illustrates a soft keyboard according to an embodiment of the invention where predicted keys have free form borderlines after expanding towards the leftover space from suppressed keys.

FIG. 7: illustrates a soft keyboard according to an embodiment of the invention where predicted keys have elliptic borderlines after expanding towards the leftover space from suppressed keys.

FIG. 8: illustrates a soft keyboard according to an embodiment of the invention where suppressed keys are not completely obscured, shown in a pale color, so suppressed keys can still be typed by a specific gesture or long tap.

FIG. 8: illustrates a soft keyboard according to an embodiment of the invention where leftover space from suppressed keys are used for showing word suggestions besides reshaping the predicted keys.

### DETAILED DESCRIPTION OF THE INVENTION

The invention is not limited tablets and smart phones, embodiments of the invention are amenable to application to any device with soft keyboard, such as (but not limited to) devices that run the iOS operating system, devices that run Android operating system, devices that run Microsoft Windows 8 operating system, such as those available from RIM and Samsung as Microsoft, Nokia, and other vendors. Embodiments of the invention are also amenable to application to standard desktop computers, as well as other devices, such as devices commonly referred to as electronic books, or e-books.

Tablets and phones have touch-sensitive display, and therefore allows for output to be displayed thereon, as well as input to be entered thereon.

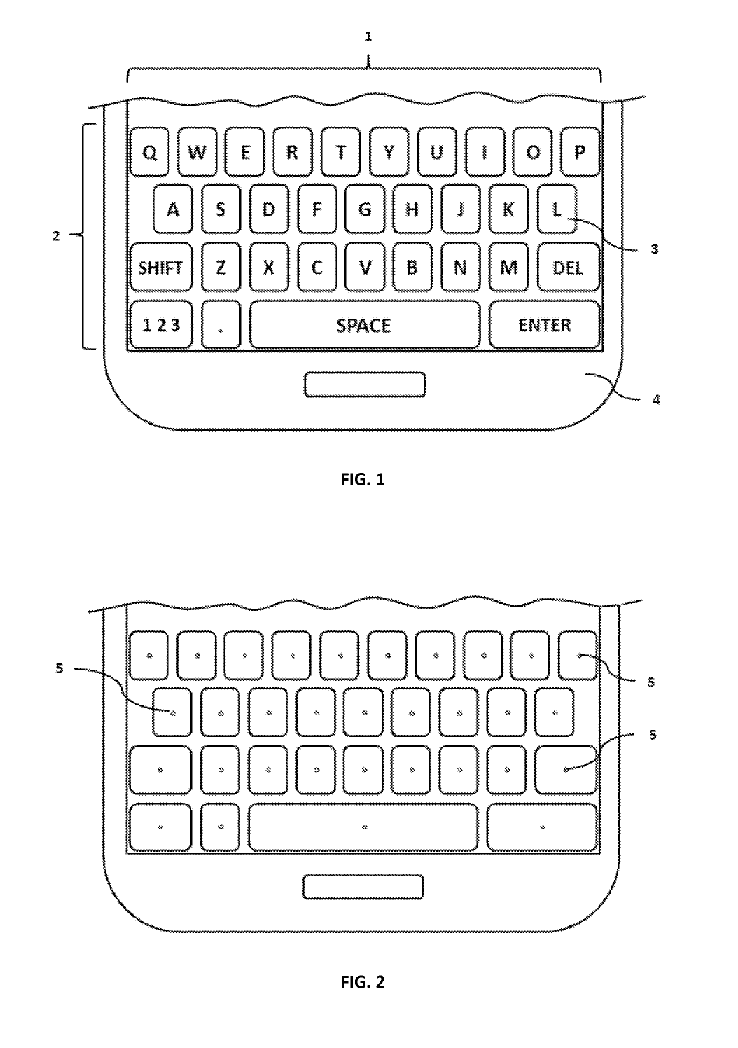

Referring next to FIG. 1, a diagram of a soft keyboard in conjunction with which embodiments of the invention may be practiced is shown. The display area 1, 2 is one part of a display of a device. The display area 1, 2 includes a soft keyboard. The soft keyboard is an image of a real keyboard displayed on the display. Because it is not an actual, physical keyboard, the keyboard is referred to as a “soft” keyboard. “Typing” on the soft keyboard means tapping on the parts of the display on which the desired keys of the keyboard are displayed, with a finger or other implement, to cause the device to recognize that inputs have been made.

Most commonly used keyboard layout is QWERTY layout. FIG. 1 illustrates a compact form of QWERTY layout soft keyboard sample. There are more than 30 keys present in most compact form of English QWERTY layout and there are up to 10 keys in one row. There are even more keys in an row in some languages' QWERTY layout. In small touch screen devices such as mobile phones the area for each keyboard key is very limited. Thus, individual keys on the soft keyboard are quite small, making for inconvenient typing on the keyboard. Users are apt to tap the incorrect key when attempting to type a desired key sequence, as has been described in the background section. Embodiments of the invention attempt to overcome this disadvantage of small devices, such as mobile phones.

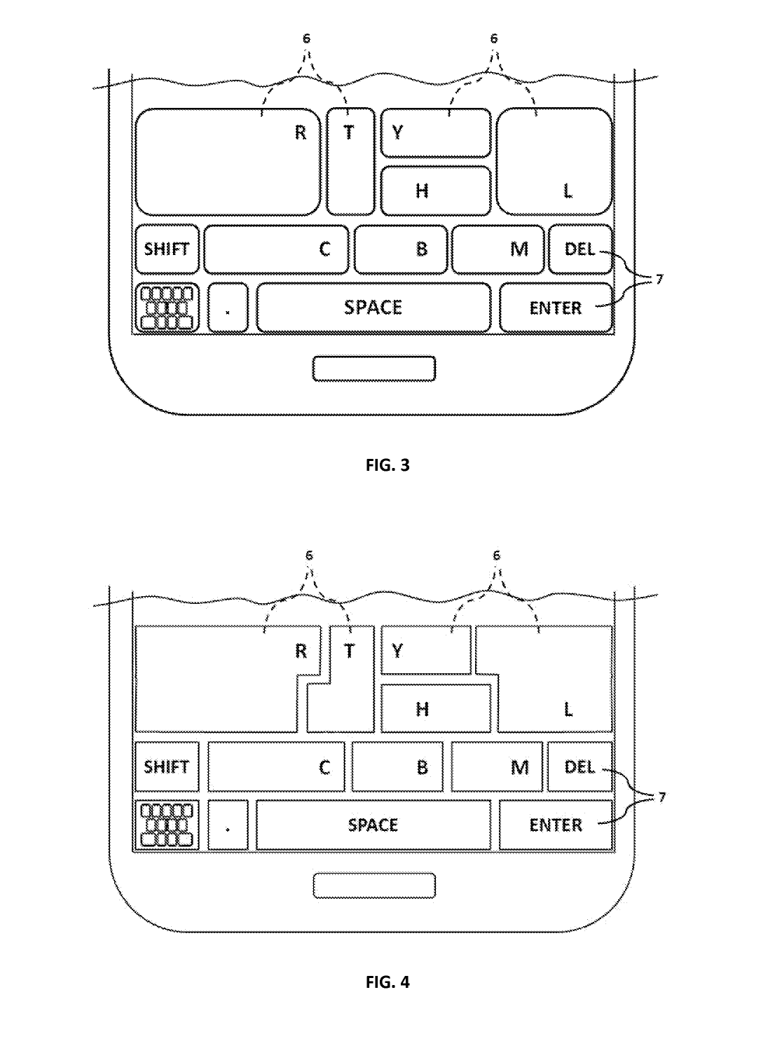

Embodiments of the invention attempt to overcome the difficulty of typing on a soft keyboard by predicting keys that are likely to be entered next, and displaying only those keys on the soft keyboard and suppressing the other keys on the keyboard. For example, as shown in FIG. 3, the letters R, T, Y, L, H, C, B and M 6 have been predicted as likely to be the next key desired to be entered by the user. These predicted keys expand towards the leftover space from suppressed keys. Predicted keys now are displayed as larger in size, so they are easy to type on the soft keyboard.

Predicting, suppressing and expanding keys happens dynamically as user types, deletes or uses a modifier key or approaches towards a key. Any user action changing probability of letters entered next is a trigger for predicting, suppressing and expanding keys.

Predicting, suppressing and expanding keys can be active all the time or it can be activated after a certain number of keys are typed, for example two consecutive inputs can be expected from user for method to activate predicting, suppressing and expanding keys for a more accurate prediction, the invention itself is not limited to this specific manner requiring input to activating the prediction.

The predicted keys to be displayed can be limited to a certain number to apportion the leftover space from suppressed keys generously, so predicted keys can be enlarged enough. For example eight letter limitation means only eight keys with highest probability of being entered next are predicted. Only these eight keys are shown on the soft keyboard. It is also possible to display all predicted keys, the invention itself is not limited to this specific manner of limiting the maximum number of key prediction.

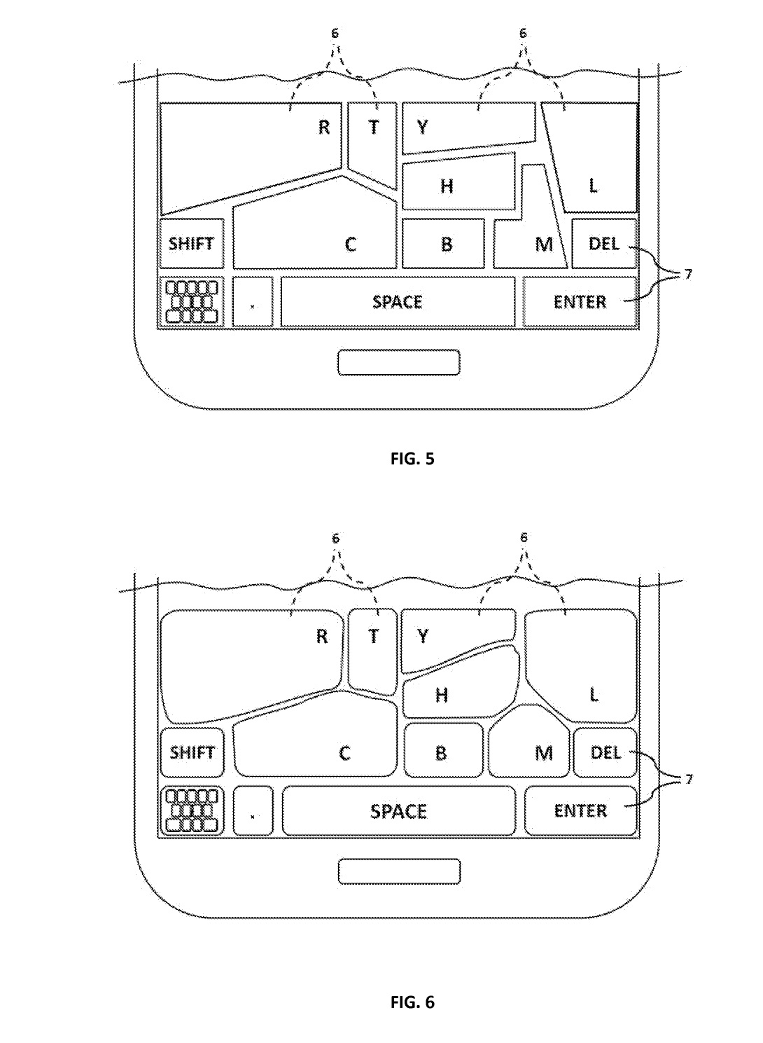

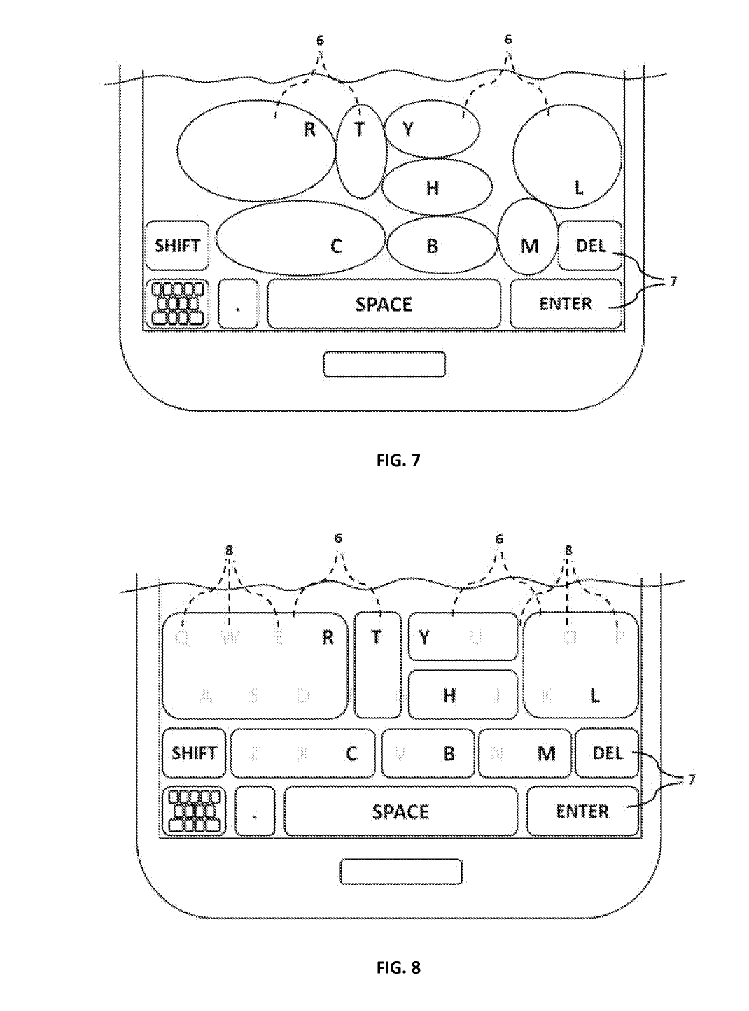

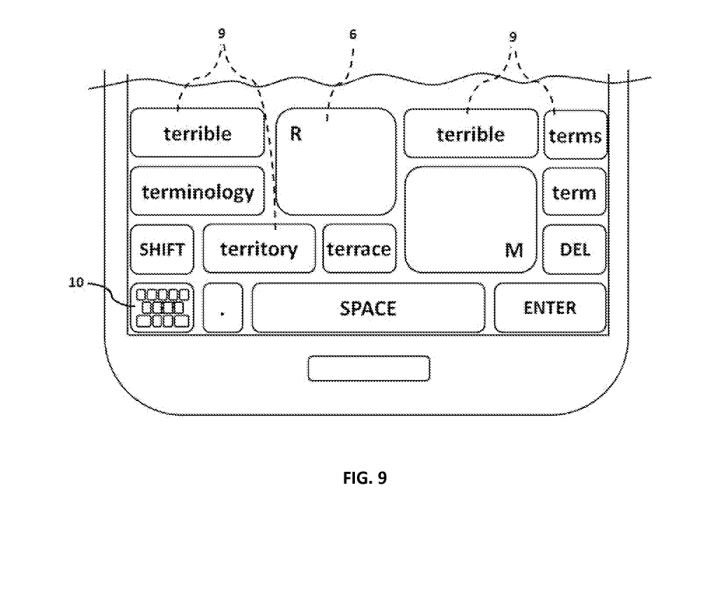

In one embodiment of the invention, only keys corresponding to letters are shown on the soft keyboard when they are predicted to likely be the next keys entered by the user. Non alphabetic keys 7, such as the space bar, the return key, keys corresponding to numerals and punctuation marks, etc., are not displayed differently on the soft keyboard in this embodiment. Furthermore, whereas in the embodiment shown in FIG. 4, FIG. 5, FIG. 6, FIG. 7 and FIG. 8, only the keys on the soft keyboard that are predicted as likely to be entered next by the user are displayed. Other alphabetic keys are suppressed, predicted keys are reshaped in order to expand towards the leftover space from suppressed keys. Reshaping predicted keys can be done in several ways as shown in FIG. 3, FIG. 4, FIG. 5, FIG. 6, FIG. 7, FIG. 8, for example by enlarging keys based on availability of leftover space around the key or by reshaping predicted keys with a specific geometric shape, or by expanding the keys based on their likelihood of being typed next, the invention itself is not limited to this specific manner of displaying keys on the soft keyboard.

The leftover space from suppressed keys can be also utilized to display suggested word or words 9 to the user based on the entered key sequence. This way users find word suggestions 9 inline the keys as they type, the invention itself is not limited to this specific manner of utilizing the left over space from suppressed keys.

In FIG. 8, suppressed keys are not entirely obscured and shown in a pale color 8 just in case the prediction is incorrect, and the user desires to type a key other than the predicted keys R, T, Y, L, H, C, B and M 6. In that case user can still type a suppresses key with a explicit gesture rather than taping, like keeping the finger over the key for a second or two or swiping on the key, the invention itself is not limited to this specific manner of typing the suppressed keys.

In case the prediction is incorrect and the user desires to type a key other than the keys corresponding to the letters R, T, Y, L, H, C, B and M 6, the prediction can be taken back and return to the standard keyboard layout by a specific key 10 on the keyboard or by a gesture, the invention itself is not limited to this specific manner of removing the prediction to return standard keyboard layout.

The center of the keys in their default position 5 is called “default center” as shown in FIG. 2. The location of the letter representation of the keys do not change even though predictive keys is enlarged or reshaped, the letter representation always stays at the default center of key as shown in FIG. 3, FIG. 4, FIG. 5, FIG. 6, FIG. 7, FIG. 8. By time users memorize locations letters on the keyboard. Keeping letter representation of the keys at default center 5 will allow users to type letters with memorized locations easily. This way users do not have to change their existing habits about key locations. The invention itself is not limited to this specific manner of locating the letter representation of the keys.

Predicting keys to be typed next happens dynamically as user types, deletes or uses a modifier key or approaches towards a key. Any user action changing likelihood of keys being typed next is a trigger for predicting keys. Some of the possible triggers for predicting keys are for example entering a letter or a number or a sign or space, deleting a letter or a number or a sign or space, activating a modifier key, moving finger towards to a key before touching to the screen, using gestures and using shortcuts, the invention itself is not limited to this specific manner of triggering keys prediction.

Likelihood of keys to be entered next can be predicted in many ways, for example by identifying the possible words being written based on already entered letters or by identifying the most used letters by key sequence statistics model or by statistical character model such as “letter n-gram” or by a statistical word model or by letter trigram model or by word bigrams and by word trigrams or by word unigram model or by identifying possible sentences being written based on the words and letters already entered or by identifying the key that user's finger moves towards to, the invention itself is not limited to any specific manner of predicting likelihood of keys to be entered next.

In this section of the detailed description, the manner by which keys are predicted as likely to be entered next by the user is described in accordance with varying embodiments of the invention. The invention is not limited to the manner described herein, however.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

We claim:

1. In a computer system having a soft keyboard a method of providing keys to a user for data input, comprising the steps of predicting keys have a probability to be entered next, wherein predicting keys includes determining keys have greater probability of being entered compared to the other keys; and suppressing keys those are not predicted as likely to be entered next; and displaying a soft keyboard where only predicted keys are displayed on the soft keyboard; and apportioning the leftover space from suppressed keys among predicted keys.

2. The method of claim 1, wherein predicting keys have a probability to be entered next comprises limiting key prediction to a certain number, only certain number of keys with highest probability of being entered next are predicted.

3. The method of claim 1, wherein predicting keys have a probability to be entered next comprises starting off predicting keys after a certain number of consecutive user inputs.

4. The method of claim 1, wherein apportioning leftover space from suppressed keys among predicted keys comprises predicted keys to expand towards left over spaces from suppressed keys.

5. The method of claim 4, wherein predicted keys to expand towards left over spaces from suppressed keys comprises enlarging predicted keys towards left over spaces from suppressed keys.

6. The method of claim 4, wherein predicted keys to expand towards left over spaces from suppressed keys comprises reshaping predicted keys in order to use up the left over spaces from suppressed keys.

7. The method of claim 4, wherein predicted keys to expand towards left over spaces from suppressed keys comprises enlarging predicted keys towards left over spaces from suppressed keys where suppressed keys are not completely obscured and still displayed underneath the predicted keys in a less explicit way to be kept available.

8. The method of claim 1, wherein displaying a soft keyboard where only predicted keys are displayed on the soft keyboard comprises utilizing leftover space from suppressed keys to display extra soft buttons.

9. The method of claim 8, wherein utilizing leftover space from suppressed keys to display extra soft buttons comprises showing word completion suggestions in the leftover space from suppressed keys.

10. The method of claim 1, wherein predicting keys have a probability to be entered next comprises triggering the prediction by any user input.

11. The method of claim 10, wherein triggering the prediction by any user input comprises triggering the prediction when user approaches towards a key.

12. The method of claim 10, wherein triggering the prediction by any user input comprises triggering the prediction when user enters a letter, number, a sign, space or deletes a letter, a number, a sign, space or activates a modifier key.

13. The method of claim 1, wherein suppressing keys those are not predicted as likely to be entered next comprises recalling suppressed keys on the soft keyboard by an user input in case prediction is not accurate.

14. The method of claim 13, wherein recalling suppressed keys on the soft keyboard comprises recalling suppressed keys by specific key on the soft keyboard.

15. The method of claim 13, wherein recalling suppressed keys on the soft keyboard comprises recalling suppressed keys by a gesture.

16. The method of claim 1, wherein displaying a soft keyboard where only predicted keys are displayed on the soft keyboard comprises keeping the letter representation of reshaped keys at keys' default center and not move it to new center of the reshaped button.

17. The method of claim 1, wherein predicting keys have a probability to be entered next comprises utilizing a statistical model to predict keys based on already entered keys of the sequence of keys.

18. The method of claim 17, wherein utilizing a statistical model to predict keys comprises utilizing one of a statistical character model and one of a statistical word model.

19. The method of claim 17, wherein utilizing a statistical model to predict keys comprises utilizing one of a statistical character model and one of a statistical word model and one of a statistical sentence model.

20. The method of claim 17, wherein utilizing a statistical model to predict keys comprises utilizing moves of user's finger above the screen before tap is happening.
